(19) United States
(12) Patent Application Publication
(10) Pub. No.: US 2025/0073612 A1
(43) Pub. Date: Mar. 6, 2025

(54) THERMOSYPHON REBOILER MODIFICATION

(71) Applicant: Saudi Arabian Oil Company, Dhahran (SA)

(72) Inventors: Jorge J. Delgado, Dhahran (SA); Papa Cisse, Dhahran (SA); Maad F. Alsasi, Dammam (SA); Abdulaziz A. Alotaibi, Dammam (SA)

(21) Appl. No.: 18/461,878

(22) Filed: Sep. 6, 2023

(51) Int. Cl. B01D 3/32; F28F 21/08

(52) U.S. Cl. CPC B01D 3/322; F28F 21/089

(57) ABSTRACT

An inner surface of a thermosyphon reboiler is engraved. The thermosyphon reboiler includes a first side configured to receive a liquid and a second side configured to receive a heating fluid. The thermosyphon reboiler is configured to transfer heat from the heating fluid at the second side to the liquid at the first side to boil the liquid at the first side. Engraving the inner surface of the thermosyphon reboiler includes engraving a pattern across at least a portion of an inner surface of the first side of the thermosyphon reboiler. The pattern has a specified depth that increases a heat transfer surface area of the first side of the thermosyphon reboiler. The engraved pattern prevents film boiling from occurring at the inner surface of the first side of the thermosyphon reboiler.

### TECHNICAL FIELD

This disclosure relates to thermosyphon reboilers.

### BACKGROUND

Distillation is the process of separating components of a liquid mixture by using selective boiling and condensation. Distillation is commonly used in the oil and gas industry to fractionate crude oil into various useful products, such as gasoline, diesel, and kerosene. Industrial distillation is typically performed in large, vertical cylindrical columns known as distillation towers. Distillation towers commonly use reboilers to supply heat at the bottom of such towers for providing a temperature gradient to separate components based on boiling points. The products with lower boiling points exit from the top of such columns, while the products with higher boiling points exit from the bottom of such columns.

### SUMMARY

This disclosure describes technologies relating to modification of thermosyphon reboilers to mitigate and/or prevent film boiling from occurring within such thermosyphon reboilers. Certain aspects of the subject matter described can be implemented as a method. An inner surface of a thermosyphon reboiler is engraved. The thermosyphon reboiler includes a first side configured to receive a liquid and a second side configured to receive a heating fluid. The thermosyphon reboiler is configured to transfer heat from the heating fluid at the second side to the liquid at the first side to boil the liquid at the first side. Engraving the inner surface of the thermosyphon reboiler includes engraving a pattern across at least a portion of an inner surface of the first side of the thermosyphon reboiler. The pattern has a specified depth that increases a heat transfer surface area of the first side of the thermosyphon reboiler. The engraved pattern prevents film boiling from occurring at the inner surface of the first side of the thermosyphon reboiler.

This, and other aspects, can include one or more of the following features. The first side of the thermosyphon reboiler can be tubular and define a first longitudinal axis. Engraving the pattern can include forming the pattern as a helix defining a second longitudinal axis. The first longitudinal axis of the first side and the second longitudinal axis of the helix can be coaxial. The specified depth of the pattern can be in a range of from about 0.05 millimeters (mm) to about 0.3 mm. The specified depth of the pattern can vary along the second longitudinal axis. The helix can have a pitch. A ratio of the pitch of the helix to the specified depth of the pattern can be in a range of from about 3:1 to about 10:1. The pitch of the helix can vary along the second longitudinal axis. The first side of the thermosyphon reboiler can be tubular and define a first longitudinal axis. The pattern can have a form of a double helix defining a second longitudinal axis. The first longitudinal axis of the first side and the second longitudinal axis of the double helix can be coaxial.

Certain aspects of the subject matter described can be implemented as a method. A tube insert is inserted in a thermosyphon reboiler. The thermosyphon reboiler includes a first side configured to receive a heating fluid and a second side configured to receive a liquid. The tube insert is inserted within the second side of the thermosyphon reboiler. The thermosyphon reboiler is configured to transfer heat from the heating fluid at the first side to the liquid at the second side to boil the liquid at the second side. The tube insert defines an engraved pattern spanning across at least a portion of a surface of the tube insert. The engraved pattern has a specified depth that is configured to increase a heat transfer surface area of the second side of the thermosyphon reboiler. The engraved pattern prevents film boiling from occurring at the second side of the thermosyphon reboiler.

This, and other aspects, can include one or more of the following features. The tube insert of the second side of the thermosyphon reboiler can define a first longitudinal axis. The engraved pattern of the tube insert can be formed as a helix defining a second longitudinal axis. The first longitudinal axis of the first side and the second longitudinal axis of the helix can be coaxial. The specified depth of the pattern can be in a range of from about 0.05 mm to about 0.3 mm. The specified depth of the pattern can vary along the second longitudinal axis. The helix can have a pitch. A ratio of the pitch of the helix to the specified depth of the pattern can be in a range of from about 3:1 to about 10:1. The pitch of the helix can vary along the second longitudinal axis. The tube insert of the second side of the thermosyphon reboiler can define a first longitudinal axis. The engraved pattern can be formed as a double helix defining a second longitudinal axis. The first longitudinal axis of the first side and the second longitudinal axis of the double helix can be coaxial. A second tube insert can be inserted within the second side of the thermosyphon reboiler. The second tube insert can define a second engraved pattern spanning across at least a portion of a surface of the second tube insert. The second engraved pattern can have a second specified depth that is configured to increase a heat transfer surface area of the second side of the thermosyphon reboiler. The second engraved pattern can further prevent film boiling occurring at the second side of the thermosyphon reboiler. The second engraved pattern of the second tube insert can be substantially the same as the engraved pattern of the tube insert.

Certain aspects of the subject matter described can be implemented as a method. An inner surface of a thermosyphon reboiler is engraved. The thermosyphon reboiler includes a first side and a second side. Engraving the inner surface of the thermosyphon reboiler includes engraving a pattern across at least a portion of an inner surface of the second side of the thermosyphon reboiler. The pattern has a specified depth that increases a heat transfer surface area of the second side of the thermosyphon reboiler. A heating fluid is flowed to the first side of the thermosyphon reboiler. A liquid is flowed to the second side of the thermosyphon reboiler. In response to flowing the heating fluid to the first side and the liquid to the second side, heat from the heating fluid at the first side is transferred to the liquid at the second side, thereby boiling the liquid at the second side. While boiling the liquid at the second side, the engraved pattern prevents film boiling from occurring at the inner surface of the second side of the thermosyphon reboiler.

This, and other aspects, can include one or more of the following features. The second side of the thermosyphon reboiler can be tubular and define a first longitudinal axis. The pattern can be formed as a helix defining a second longitudinal axis. The specified depth of the pattern can be in a range of from about 0.05 mm to about 0.3 mm. The specified depth of the pattern can vary along the second longitudinal axis. The helix can have a pitch. A ratio of the pitch of the helix to the specified depth of the pattern can be in a range of from about 3:1 to about 10:1. The pitch of the helix can vary along the second longitudinal axis.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example horizontal thermosyphon reboiler.

FIG. 2 is a schematic diagram of an example vertical thermosyphon reboiler.

FIG. 3 is a flow chart of an example method for modifying a thermosyphon reboiler.

FIG. 4 is a flow chart of an example method for modifying a thermosyphon reboiler.

FIG. 5 is a flow chart of an example method for modifying a thermosyphon reboiler.

### DETAILED DESCRIPTION

This disclosure describes modification of thermosyphon reboilers to mitigate and/or prevent film boiling within such thermosyphon reboilers. Film boiling is a form of change-of-phase heat transfer characterized by a solid body (such as a tube of the thermosyphon reboiler) transferring heat to a liquid through an intermediate vapor film. The intermediate vapor film forms a continuous blanket over the solid surface that hinders transfer of heat from the solid surface to the liquid that is to be boiled. In effect, the intermediate vapor film acts as an insulating blanket that detrimentally affects the boiling capability of the thermosyphon reboiler. As such, mitigating and/or preventing the occurrence of film boiling in thermosyphon reboilers can be beneficial, if not essential. A surface of a thermosyphon reboiler is engraved with a pattern. The engraved pattern has a specified depth that increases a heat transfer surface area of the thermosyphon reboiler. The engraved pattern is configured to mitigate and/or prevent film boiling from occurring at the heat transfer surface area of the thermosyphon reboiler.

The subject matter described in this disclosure can be implemented in particular implementations, so as to realize one or more of the following advantages. The thermosyphon reboilers and methods described herein can be implemented to mitigate and/or prevent film boiling from occurring within such thermosyphon reboilers. The modifications described herein can be implemented on existing thermosyphon reboilers (retro-fitting) or newly fabricated thermosyphon reboilers. In some cases, tube inserts with engravings can be fabricated and installed within the tube of a thermosyphon reboiler. The tube inserts can be newly installed or replace already existing tubes within the thermosyphon reboiler. By preventing film boiling within thermosyphon reboilers, operating costs and maintenance costs can be reduced. Prevention of film boiling within thermosyphon reboilers can also reduce and/or eliminate downtime associated with maintaining and/or repairing thermosyphon reboilers. Mitigation or elimination of film boiling within thermosyphon reboilers can increase the performance of such reboilers and allow for improved throughput during revamping activities.

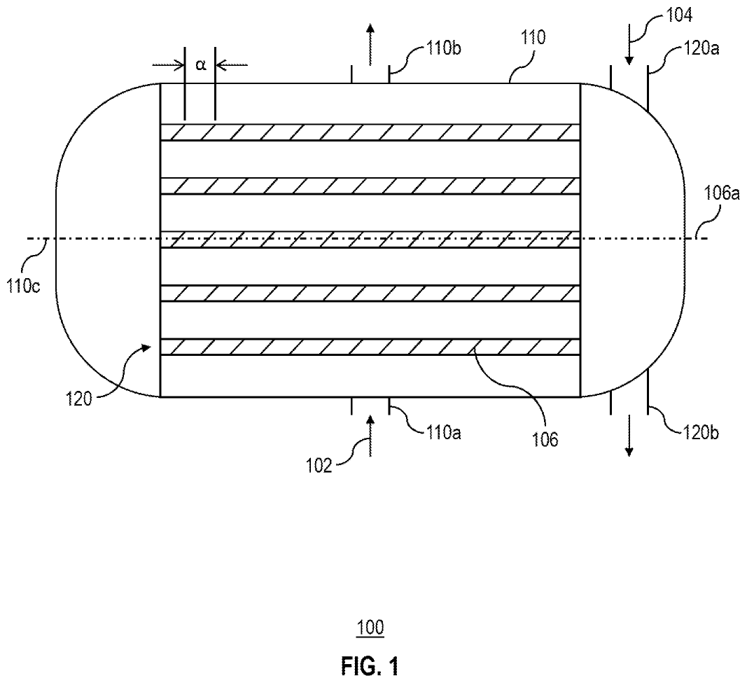

FIG. 1 depicts an example thermosyphon reboiler 100. The thermosyphon reboiler 100 is a natural circulation reboiler, as opposed to a forced circulation reboiler. As such, the thermosyphon reboiler 100 utilizes a gradient (for example, in pressure, density, temperature, or any combinations of these) between an inlet 110a of the thermosyphon reboiler 100 and an outlet 110b of the thermosyphon reboiler 100 to circulate a fluid (that is to be fractionated) through the thermosyphon reboiler 100 and the distillation tower (not shown) to which the thermosyphon reboiler 100 is connected. The thermosyphon reboiler 100 is configured to circulate the fluid independent of a pump, which is typically required in forced circulation reboilers.

The thermosyphon reboiler 100 includes a first side 110 and a second side 120. In some implementations, the thermosyphon reboiler 100 is a shell-and-tube-type heat exchanger. In some implementations, as shown in FIG. 1, the thermosyphon reboiler 100 is a horizontal thermosyphon reboiler. The first side 110 can, for example, be the shell side of the thermosyphon reboiler 100. The second side 120 can, for example, be the tube side (disposed within the shell side) of the thermosyphon reboiler 100. The first side 110 is configured to receive a process fluid 102 (liquid) via the inlet 110a. The second side 120 is configured to receive a heating fluid 104 (such as steam or hot oil) via an inlet 120a. The thermosyphon reboiler 100 is configured to transfer heat from the heating fluid 104 at the second side 120 to the process fluid 102 at the first side 110 to boil the process fluid 102 at the first side 110. In some implementations, the process fluid 102 is completely vaporized and exits the first side 110 as a vapor via the outlet 110b. In some implementations, the process fluid 102 is partially vaporized and exits the first side 110 as a vapor-liquid mixture via the outlet 110b. For example, the process fluid 102 exiting the outlet 110b has a vapor fraction of about 30%. Boiling the process fluid 102 at the first side 110 induces a larger gradient (for example, in pressure and density) across the process fluid 102, which facilitates flow of the process fluid 102 from the inlet 110a to the outlet 110b.

At least a portion of an inner surface of the thermosyphon reboiler 100 is engraved with a pattern 106. In some implementations, at least a portion of an inner surface of the first side 110 is engraved with the pattern 106. For example, the pattern 106 is engraved on an outer, circumferential surface of the tubes of the second side 120. The outer surface of the tubes of the second side 120 are exposed to the process fluid 102 because the tubes of the second side 120 are disposed within the shell of the first side 120, while the heating fluid 104 flows through the tubes of the second side 120. Thus, the outer surface of the tubes of the second side 120 make up at least a portion of the heat transfer surface area of the thermosyphon reboiler 100. The pattern 106 has a specified depth that increases the heat transfer surface area of the first side 110. The engraved pattern 106 mitigates and/or prevents the occurrence of film boiling at the inner surface of the first side 110 of the thermosyphon reboiler 100. In some implementations, the specified depth (that is, depth of the engraving into the inner surface of the first side 110) of the pattern 106 is in a range of from about 0.05 millimeters (mm) to about 0.3 mm. The width of the engraved pattern 106 can be substantially similar to the depth of the engraved pattern 106. For example, the width of the engraved pattern 106 is in a range of from about 0.05 mm to about 0.3 mm.

In some implementations, the first side 110 of the thermosyphon reboiler 100 is tubular and defines a longitudinal axis 110c. In some implementations, the pattern 106 is formed as a helix that defines a longitudinal axis 106a. In some implementations, as shown in FIG. 1, the longitudinal axis 110c of the first side 110 and the longitudinal axis 106a of the pattern 106 are coaxial. The helix of the pattern 106 has a pitch (α). In some implementations, the ratio of the pitch (α) to the depth of the engraved pattern 106 can be in a range of from about 3:1 to about 10:1. In some implementations, the pitch & is uniform along the longitudinal axis 106a. In some implementations, the pitch a varies along the longitudinal axis 106a. For example, the pitch a can increase in a general direction of fluid flow of the process fluid 102 from the inlet 110a to the outlet 110b. In some implementations, the specified depth of the pattern 106 is uniform along the longitudinal axis 106a. In some implementations, the specified depth of the pattern 106 varies along the longitudinal axis 106a. For example, the specified depth of the pattern 106 can decrease in the general direction of fluid flow of the process fluid 102 from the inlet 110a to the outlet 110b. In some implementations, the pattern 106 is formed as a double helix that has similar of substantially the same characteristics of the helix.

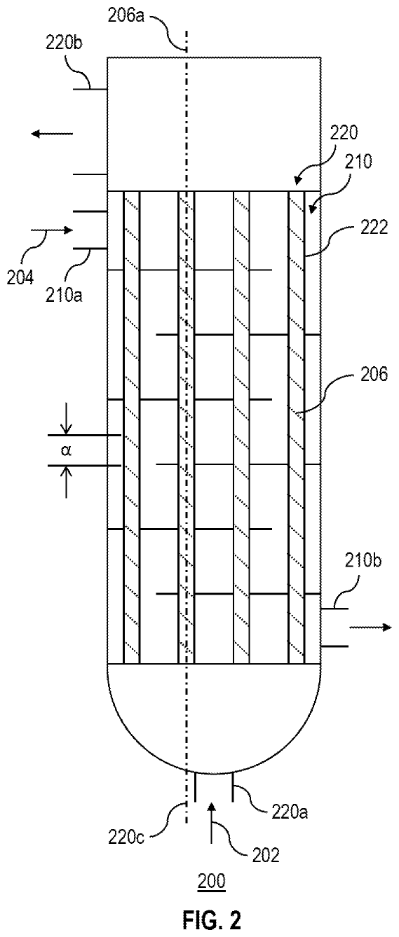

FIG. 2 depicts an example thermosyphon reboiler 200. The thermosyphon reboiler 200 is a natural circulation reboiler, as opposed to a forced circulation reboiler. As such, the thermosyphon reboiler 200 utilizes a gradient (for example, in pressure, density, temperature, or any combinations of these) between an inlet 220a of the thermosyphon reboiler 200 and an outlet 220b of the thermosyphon reboiler 200 to circulate a fluid (that is to be fractionated) through the thermosyphon reboiler 200 and the distillation tower (not shown) to which the thermosyphon reboiler 200 is connected. The thermosyphon reboiler 200 is configured to circulate the fluid independent of a pump, which is typically required in forced circulation reboilers.

The thermosyphon reboiler 200 includes a first side 210 and a second side 220. In some implementations, the thermosyphon reboiler 200 is a shell-and-tube-type heat exchanger. In some implementations, as shown in FIG. 2, the thermosyphon reboiler 200 is a vertical thermosyphon reboiler. The first side 210 can, for example, be the shell side of the thermosyphon reboiler 200. The second side 220 can, for example, be the tube side (disposed within the shell side) of the thermosyphon reboiler 200. The second side 220 includes a tube insert 222. The tube insert 222 can be inserted in a tube of the second side 220. As shown in FIG. 2, the second side 220 can include multiple tube inserts 222. For example, each tube of the second side 220 can include a tube insert 222. For simplicity and clarity, the tube insert 222 is described as a single component, but the same properties and characteristics of the tube insert 222 can be applied to all tube inserts 222 that are included in the thermosyphon reboiler 200. The first side 210 is configured to receive a heating fluid 204 (such as steam) via the inlet 210a. The second side 220 (tube insert 222) is configured to receive a process fluid 202 (liquid) via an inlet 220a. The thermosyphon reboiler 200 is configured to transfer heat from the heating fluid 204 at the first side 210 to the process fluid 202 at the second side 220 to boil the process fluid 202 at the second side 220. In some implementations, the process fluid 202 is completely vaporized and exits the second side 220 as a vapor via the outlet 220b. In some implementations, the process fluid 202 is partially vaporized and exits the second side 220 as a vapor-liquid mixture via the outlet 220b. For example, the process fluid 202 exiting the outlet 220b has a vapor fraction of about 30%. Boiling the process fluid 202 at the second side 220 induces a larger gradient (for example, in pressure and density) across the process fluid 202, which facilitates flow of the process fluid 202 from the inlet 220a to the outlet 220b.

At least a portion of a surface of the thermosyphon reboiler 200 is engraved with a pattern 206. In some implementations, at least a portion of an inner surface of the second side 220 is engraved with the pattern 206. For example, at least a portion of an inner surface of the tube inserts 222 (through which the process fluid 202 flows) is engraved with the pattern 206. The pattern 206 has a specified depth that increases a heat transfer surface area of the second side 220. The engraved pattern 206 mitigates and/or prevents the occurrence of film boiling at the inner surface of the second side 220 of the thermosyphon reboiler 200. In some implementations, the specified depth (that is, depth of the engraving into the inner surface of the second side 220) of the pattern 206 is in a range of from about 0.05 mm to about 0.3 mm. The width of the engraved pattern 206 can be substantially similar to the depth of the engraved pattern 206. For example, the width of the engraved pattern 206 is in a range of from about 0.05 mm to about 0.3 mm.

In some implementations, the tube insert 222 of the second side 220 of the thermosyphon reboiler 200 is tubular and defines a longitudinal axis 220c. In some implementations, the pattern 206 is formed as a helix that defines a longitudinal axis 206a. In some implementations, as shown in FIG. 2, the longitudinal axis 220e of the tube insert 222 and the longitudinal axis 206a of the pattern 206 are coaxial. The helix of the pattern 206 has a pitch (α). In some implementations, the ratio of the pitch (α) to the depth of the engraved pattern 206 can be in a range of from about 3:1 to about 10:1. In some implementations, the pitch a is uniform along the longitudinal axis 206a. In some implementations, the pitch a varies along the longitudinal axis 206a. For example, the pitch a can increase in a general direction of fluid flow of the process fluid 202 from the inlet 220a to the outlet 220b. In some implementations, the specified depth of the pattern 206 is uniform along the longitudinal axis 206a. In some implementations, the specified depth of the pattern 206 varies along the longitudinal axis 206a. For example, the specified depth of the pattern 206 can decrease in the general direction of fluid flow of the process fluid 202 from the inlet 220a to the outlet 220b. In some implementations, the pattern 206 is formed as a double helix that has similar or substantially the same characteristics of the helix.

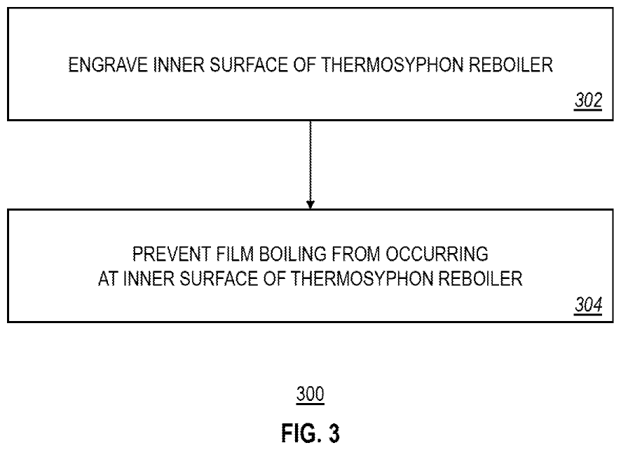

FIG. 3 is a flow chart of an example method 300 for modifying a thermosyphon reboiler. The method 300 can, for example, be implemented to form the thermosyphon reboiler 100 shown in FIG. 1. At block 302, an inner surface of a thermosyphon reboiler (such as the thermosyphon reboiler 100) is engraved. As described previously, the thermosyphon reboiler 100 includes a first side 110 and a second side 120. The first side 110 is configured to receive a process fluid 102 (liquid), and the second side 120 is configured to receive a heating fluid 104 (such as steam). The thermosyphon reboiler 100 transfers heat from the heating fluid 104 at the second side 120 to the process fluid 102 at the first side 110 to boil the process fluid 102 at the first side 110. Engraving the inner surface of the thermosyphon reboiler 100 at block 302 includes engraving a pattern (such as the engraved pattern 106) across at least a portion of an inner surface of the first side 110 of the thermosyphon reboiler 100 (for example, an outer circumferential surface of the tubes). For example, the pattern 106 is engraved on an outer surface of the tubes of the second side 120. The outer surface of the tubes of the second side 120 are exposed to the process fluid 102 because the tubes of the second side 120 are disposed within the shell of the first side 120, while the heating fluid 104 flows through the tubes of the second side 120. Thus, the outer surface of the tubes of the second side 120 make up at least a portion of the heat transfer surface area of the thermosyphon reboiler 100. As described previously, the engraved pattern 106 has a specified depth that increases a heat transfer surface area of the first side 110 of the thermosyphon reboiler 100. At block 304, the engraved pattern 106 prevents film boiling from occurring at the inner surface of the first side 110 of the thermosyphon reboiler 100.

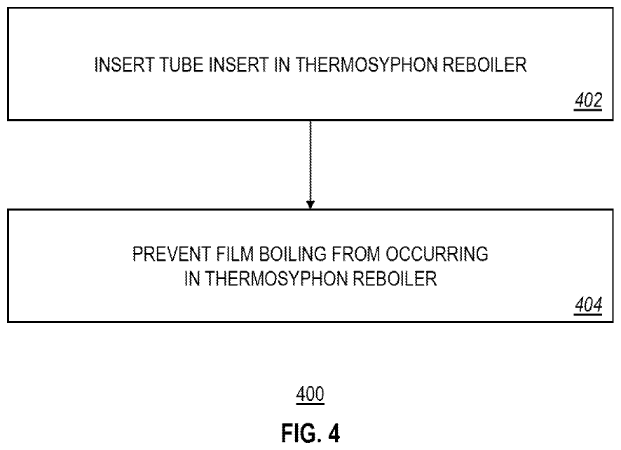

FIG. 4 is a flow chart of an example method 400 for modifying a thermosyphon reboiler. The method 400 can, for example, be implemented to form the thermosyphon reboiler 200 shown in FIG. 2. At block 402, a tube insert (such as the tube insert 222) is inserted in a thermosyphon reboiler (such as the thermosyphon reboiler 200). As described previously, the thermosyphon reboiler 200 includes a first side 210 that is configured to receive a heating fluid 204. The thermosyphon reboiler 200 includes a second side 220 that is configured to receive a process fluid 202. The tube insert 222 is inserted within the second side 220 of the thermosyphon reboiler 200 at block 402. For example, the tube insert 222 is inserted in a tube of the second side 220 of the thermosyphon reboiler 200 at block 402. The thermosyphon reboiler 200 transfers heat from the heating fluid 204 at the first side 210 to the process fluid 202 at the second side 220 to boil the process fluid 202 at the second side 220. The tube insert 222 defines an engraved pattern 206 that spans across at least a portion of a surface of the tube insert 222. In some implementations (as shown in FIG. 2), the pattern 206 is engraved across at least a portion of an inner surface of the tube insert 222. The engraved pattern (206) has a specified depth that is configured to increase a heat transfer surface area of the second side (220) of the thermosyphon reboiler (200). At block 404, the engraved pattern (206) prevents film boiling from occurring at the second side (220) of the thermosyphon reboiler (200). In some implementations, a second tube insert (such as a second implementation of the tube insert 222) is inserted in the second side 220 of the thermosyphon reboiler 200. The second tube insert can further prevent film boiling from occurring at the second side 220 of the thermosyphon reboiler 200. For example, each tube of the second side 220 of the thermosyphon reboiler 200 can include a tube insert 222.

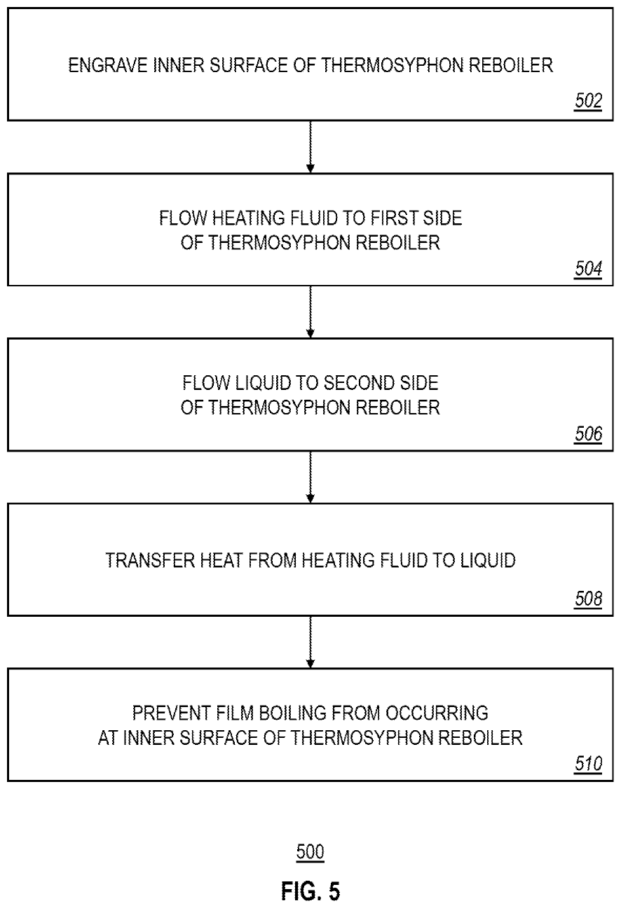

FIG. 5 is a flow chart of an example method 500 for modifying and using a thermosyphon reboiler. The method 500 can, for example, be implemented to form and use the thermosyphon 100 shown in FIG. 1. At block 502, an inner surface of a thermosyphon reboiler (such as the thermosyphon reboiler 100) is engraved. As described previously, the thermosyphon reboiler 100 includes a first side 110 and a second side 120. Engraving the inner surface of the thermosyphon reboiler 100 at block 502 includes engraving a pattern (such as the engraved pattern 106) across at least a portion of an inner surface of the first side 110 of the thermosyphon reboiler 100. As described previously, the engraved pattern 106 has a specified depth that increases a heat transfer surface area of the first side 110 of the thermosyphon reboiler 100. At block 504, a process fluid 102 (liquid) is flowed to the first side 110 of the thermosyphon reboiler 100, for example, via the inlet 110a. At block 506, a heating fluid 104 (such as steam or hot oil) is flowed to the second side 120 of the thermosyphon reboiler 100, for example, via the inlet 120a. In response to flowing the process fluid 102 to the first side 110 (block 504) and the heating fluid 104 to the second side 120 (block 506), heat is transferred from the heating fluid 104 at the second side 120 to the process fluid 102 at the first side 110 at block 508, thereby boiling the process fluid 102 at the first side 110. While boiling the process fluid 102 at the first side 110 at block 508, the engraved pattern 106 prevents film boiling from occurring at the inner surface of the first side 110 of the thermosyphon reboiler 100 at block 510.

### Embodiments

In an example implementation (or aspect), a method comprises: engraving an inner surface of a thermosyphon reboiler, wherein the thermosyphon reboiler comprises a first side configured to receive a liquid and a second side configured to receive a heating fluid, wherein the thermosyphon reboiler is configured to transfer heat from the heating fluid at the second side to the liquid at the first side to boil the liquid at the first side, wherein engraving the inner surface of the thermosyphon reboiler comprises engraving a pattern across at least a portion of an inner surface of the first side of the thermosyphon reboiler, wherein the pattern has a specified depth that increases a heat transfer surface area of the first side of the thermosyphon reboiler; and preventing, by the engraved pattern, film boiling from occurring at the inner surface of the first side of the thermosyphon reboiler.

In an example implementation (or aspect) combinable with any other example implementation (or aspect), the first side of the thermosyphon reboiler is tubular and defines a first longitudinal axis, wherein engraving the pattern comprises forming the pattern as a helix defining a second longitudinal axis, wherein the first longitudinal axis of the first side and the second longitudinal axis of the helix are coaxial.

In an example implementation (or aspect) combinable with any other example implementation (or aspect), the specified depth of the pattern is in a range of from about 0.05 millimeters (mm) to about 0.3 mm.

In an example implementation (or aspect) combinable with any other example axis.

In an example implementation (or aspect) combinable with any other example implementation (or aspect), the helix has a pitch, and a ratio of the pitch of the helix to the specified depth of the pattern is in a range of from about 3:1 to about 10:1.

In an example implementation (or aspect) combinable with any other example implementation (or aspect), the pitch of the helix varies along the second longitudinal axis.

In an example implementation (or aspect) combinable with any other example implementation (or aspect), the first side of the thermosyphon reboiler is tubular and defines a first longitudinal axis, the pattern has a form of a double helix defining a second longitudinal axis, and the first longitudinal axis of the first side and the second longitudinal axis of the double helix are coaxial.

In an example implementation (or aspect), a method comprises: inserting a tube insert in a thermosyphon reboiler, wherein the thermosyphon reboiler comprises a first side configured to receive a heating fluid and a second side configured to receive a liquid, wherein the tube insert is inserted within the second side of the thermosyphon reboiler, wherein the thermosyphon reboiler is configured to transfer heat from the heating fluid at the first side to the liquid at the second side to boil the liquid at the second side, wherein the tube insert defines an engraved pattern spanning across at least a portion of a surface of the tube insert, wherein the engraved pattern has a specified depth that is configured to increase a heat transfer surface area of the second side of the thermosyphon reboiler; and preventing, by the engraved pattern, film boiling from occurring at the second side of the thermosyphon reboiler.

In an example implementation (or aspect) combinable with any other example implementation (or aspect), the tube insert of the second side of the thermosyphon reboiler defines a first longitudinal axis; the engraved pattern of the tube insert is formed as a helix defining a second longitudinal axis; and the first longitudinal axis of the first side and the second longitudinal axis of the helix are coaxial.

In an example implementation (or aspect) combinable with any other example implementation (or aspect), the specified depth of the pattern is in a range of from about 0.05 millimeters (mm) to about 0.3 mm.

In an example implementation (or aspect) combinable with any other example axis.

In an example implementation (or aspect) combinable with any other example implementation (or aspect), the helix has a pitch, and a ratio of the pitch of the helix to the specified depth of the pattern is in a range of from about 3:1 to about 10:1.

In an example implementation (or aspect) combinable with any other example implementation (or aspect), the pitch of the helix varies along the second longitudinal axis.

In an example implementation (or aspect) combinable with any other example implementation (or aspect), the tube insert of the second side of the thermosyphon reboiler defines a first longitudinal axis; the engraved pattern is formed as a double helix defining a second longitudinal axis; and the first longitudinal axis of the first side and the second longitudinal axis of the double helix are coaxial.

In an example implementation (or aspect) combinable with any other example implementation (or aspect), the method comprises: inserting a second tube insert within the second side of the thermosyphon reboiler, wherein the second tube insert defines a second engraved pattern spanning across at least a portion of a surface of the second tube insert, wherein the second engraved pattern has a second specified depth that is configured to increase a heat transfer surface area of the second side of the thermosyphon reboiler; and further preventing, by the second engraved pattern, film boiling occurring at the second side of the thermosyphon reboiler.

In an example implementation (or aspect) combinable with any other example implementation (or aspect), the second engraved pattern of the second tube insert is substantially the same as the engraved pattern of the tube insert.

In an example implementation (or aspect), a method comprises: engraving an inner surface of a thermosyphon reboiler, wherein the thermosyphon reboiler comprises a first side and a second side, wherein engraving the inner surface of the thermosyphon reboiler comprises engraving a pattern across at least a portion of an inner surface of the second side of the thermosyphon reboiler, wherein the pattern has a specified depth that increases a heat transfer surface area of the second side of the thermosyphon reboiler; flowing a heating fluid to the first side of the thermosyphon reboiler; flowing a liquid to the second side of the thermosyphon reboiler; in response to flowing the heating fluid to the first side and the liquid to the second side, transferring heat from the heating fluid at the first side to the liquid at the second side, thereby boiling the liquid at the second side; and while boiling the liquid at the second side, preventing, by the engraved pattern, film boiling from occurring at the inner surface of the second side of the thermosyphon reboiler.

In an example implementation (or aspect) combinable with any other example implementation (or aspect), the second side of the thermosyphon reboiler is tubular and defines a first longitudinal axis, and the pattern is formed as a helix defining a second longitudinal axis.

In an example implementation (or aspect) combinable with any other example implementation (or aspect), the specified depth of the pattern is in a range of from about 0.05 millimeters (mm) to about 0.3 mm, and the specified depth of the pattern varies along the second longitudinal axis.

In an example implementation (or aspect) combinable with any other example implementation (or aspect), the helix has a pitch, a ratio of the pitch of the helix to the specified depth of the pattern is in a range of from about 3:1 to about 10:1, and the pitch of the helix varies along the second longitudinal axis.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a.” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%. 3.3% to 4.4%) within the indicated range. The statement “X to Y” has the same meaning as “about X to about Y,” unless indicated otherwise. Likewise, the statement “X. Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A method comprising:
engraving an inner surface of a thermosyphon reboiler, wherein the thermosyphon reboiler comprises a first side configured to receive a liquid and a second side configured to receive a heating fluid, wherein the thermosyphon reboiler is configured to transfer heat from the heating fluid at the second side to the liquid at the first side to boil the liquid at the first side, wherein engraving the inner surface of the thermosyphon reboiler comprises engraving a pattern across at least a portion of an inner surface of the first side of the thermosyphon reboiler, wherein the pattern has a specified depth that increases a heat transfer surface area of the first side of the thermosyphon reboiler; and
preventing, by the engraved pattern, film boiling from occurring at the inner surface of the first side of the thermosyphon reboiler.

2. The method of claim 1, wherein the first side of the thermosyphon reboiler is tubular and defines a first longitudinal axis, wherein engraving the pattern comprises forming the pattern as a helix defining a second longitudinal axis, wherein the first longitudinal axis of the first side and the second longitudinal axis of the helix are coaxial.

3. The method of claim 2, wherein the specified depth of the pattern is in a range of from about 0.05 millimeters (mm) to about 0.3 mm.

4. The method of claim 3, wherein the specified depth of the pattern varies along the second longitudinal axis.

5. The method of claim 2, wherein the helix has a pitch, and a ratio of the pitch of the helix to the specified depth of the pattern is in a range of from about 3:1 to about 10:1.

6. The method of claim 5, wherein the pitch of the helix varies along the second longitudinal axis.

7. The method of claim 1, wherein the first side of the thermosyphon reboiler is tubular and defines a first longitudinal axis, the pattern has a form of a double helix defining a second longitudinal axis, and the first longitudinal axis of the first side and the second longitudinal axis of the double helix are coaxial.

8. A method comprising:
inserting a tube insert in a thermosyphon reboiler, wherein the thermosyphon reboiler comprises a first side configured to receive a heating fluid and a second side configured to receive a liquid, wherein the tube insert is inserted within the second side of the thermosyphon reboiler, wherein the thermosyphon reboiler is configured to transfer heat from the heating fluid at the first side to the liquid at the second side to boil the liquid at the second side, wherein the tube insert defines an engraved pattern spanning across at least a portion of a surface of the tube insert, wherein the engraved pattern has a specified depth that is configured to increase a heat transfer surface area of the second side of the thermosyphon reboiler; and
preventing, by the engraved pattern, film boiling from occurring at the second side of the thermosyphon reboiler.

9. The method of claim 8, wherein:
the tube insert of the second side of the thermosyphon reboiler defines a first longitudinal axis;
the engraved pattern of the tube insert is formed as a helix defining a second longitudinal axis; and
the first longitudinal axis of the first side and the second longitudinal axis of the helix are coaxial.

10. The method of claim 9, wherein the specified depth of the pattern is in a range of from about 0.05 millimeters (mm) to about 0.3 mm.

11. The method of claim 10, wherein the specified depth of the pattern varies along the second longitudinal axis.

12. The method of claim 9, wherein the helix has a pitch, and a ratio of the pitch of the helix to the specified depth of the pattern is in a range of from about 3:1 to about 10:1.

13. The method of claim 12, wherein the pitch of the helix varies along the second longitudinal axis.

14. The method of claim 8, wherein:
the tube insert of the second side of the thermosyphon reboiler defines a first longitudinal axis;
the engraved pattern is formed as a double helix defining a second longitudinal axis; and
the first longitudinal axis of the first side and the second longitudinal axis of the double helix are coaxial.

15. The method of claim 8, comprising:
inserting a second tube insert within the second side of the thermosyphon reboiler, wherein the second tube insert defines a second engraved pattern spanning across at least a portion of a surface of the second tube insert, wherein the second engraved pattern has a second specified depth that is configured to increase a heat transfer surface area of the second side of the thermosyphon reboiler; and
further preventing, by the second engraved pattern, film boiling occurring at the second side of the thermosyphon reboiler.

16. The method of claim 15, wherein the second engraved pattern of the second tube insert is substantially the same as the engraved pattern of the tube insert.

17. A method comprising:
engraving an inner surface of a thermosyphon reboiler, wherein the thermosyphon reboiler comprises a first side and a second side, wherein engraving the inner surface of the thermosyphon reboiler comprises engraving a pattern across at least a portion of an inner surface of the second side of the thermosyphon reboiler, wherein the pattern has a specified depth that increases a heat transfer surface area of the second side of the thermosyphon reboiler;
flowing a heating fluid to the first side of the thermosyphon reboiler;
flowing a liquid to the second side of the thermosyphon reboiler;
in response to flowing the heating fluid to the first side and the liquid to the second side, transferring heat from the heating fluid at the first side to the liquid at the second side, thereby boiling the liquid at the second side; and
while boiling the liquid at the second side, preventing, by the engraved pattern, film boiling from occurring at the inner surface of the second side of the thermosyphon reboiler.

18. The method of claim 17, wherein the second side of the thermosyphon reboiler is tubular and defines a first longitudinal axis, and the pattern is formed as a helix defining a second longitudinal axis.

19. The method of claim 18, wherein the specified depth of the pattern is in a range of from about 0.05 millimeters (mm) to about 0.3 mm, and the specified depth of the pattern varies along the second longitudinal axis.

20. The method of claim 18, wherein the helix has a pitch, a ratio of the pitch of the helix to the specified depth of the pattern is in a range of from about 3:1 to about 10:1, and the pitch of the helix varies along the second longitudinal axis.
